(19) United States
(12) Patent Application Publication
(10) Pub. No.: US 2009/0262970 A1
(43) Pub. Date: Oct. 22, 2009

(54) HEADSET HAVING FERRITE BEADS FOR IMPROVING ANTENNA PERFORMANCE

(75) Inventors: Jong Woo SHIN, Suwon-si (KR); Yong Lae CHEONG, Yongin-si (KR); Ki Heung HAN, Seoul (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/421,407

(22) Filed: Apr. 9, 2009

(30) Foreign Application Priority Data
Apr. 22, 2008 (KR) 10-2008-0036954

(51) Int. Cl. H04R 25/00

(52) U.S. Cl. 381/384

(57) ABSTRACT

A headset having ferrite beads for improving performance of an antenna provided within a cable is provided. The headset includes an ear jack, an ear jack Printed Circuit Board (PCB) connected to the ear jack, a speaker, and a cable having an antenna in which one end of the antenna is connected to the ear jack PCB, and having an audio line in which one end of the audio line is connected to the ear jack PCB through ferrite beads and the other end of the audio line is connected to the speaker. Therefore, by connecting an audio line within a cable to a PCB through ferrite beads, performance of an antenna provided within the cable may be improved.

### PRIORITY

This application claims the benefit under 35 U.S.C. §119(a) of a Korean patent application filed in the Korean Intellectual Property Office on Apr. 22, 2008 and assigned Serial No. 10-2008-0036954, the entire disclosure of which is hereby incorporated by reference.

### BACKGROUND OF THE INVENTION

1. Field of the Invention

The present invention relates to a headset. More particularly, the present invention relates to a headset having ferrite beads for improving performance of an antenna provided within a cable.

2. Description of the Related Art

A mobile terminal is an electronic device that enables a user to perform wireless communication and short range communication regardless of time and location. Presently, a typical mobile terminal additionally has a function of reproducing music or a moving picture. An earphone or a headphone can be used with the mobile terminal in order to listen to music or sound of the moving picture.

FIG. 1A is a perspective view illustrating a conventional headset, and FIG. 1B is a diagram illustrating connection of an ear jack Printed Circuit Board (PCB) and a microphone PCB of the conventional headset of FIG. 1A.

Referring to FIGS. 1A and 1B, a headset 100 includes an ear jack 110, microphone 130 and speaker 150. The ear jack 110 is connected to an ear jack PCB 120, and the microphone 130 is connected to a microphone PCB 140. The ear jack 110 connects the headset 100 to an external appliance, such as a mobile terminal. By inserting the ear jack 110 into the external appliance, the user can listen to sound output from the external appliance through the speaker 150. The ear jack PCB 120 and the microphone PCB 140 are connected to a cable 160. The cable 160 is connected to the ear jack PCB 120 and the microphone PCB 140 through PCB pads 180.

The cable 160 includes an antenna 161 and first audio lines 162. The antenna 161 is used for receiving an FM radio broadcasting frequency. The microphone PCB 140 and the speaker 150 are connected by second audio lines 170. The second audio lines 170 are connected to the microphone PCB 140 through the PCB pads 180.

Accordingly, because the antenna 161 is fastened to the same cable as the first audio lines 162, namely the cable 160, the antenna 161 and the first audio lines 162 are very closely disposed. Thereby, noise occurring in the first audio lines 162 may have a negative influence on performance of the antenna 161.

Therefore, a need exists for a headset for improving performance of an antenna.

### SUMMARY OF THE INVENTION

An aspect of the present invention is to address at least the above-mentioned problems and/or disadvantages and to provide at least the advantages described below. Accordingly, an aspect of the present invention is to provide a headset having ferrite beads that may improve performance of an antenna provided within a cable.

Another aspect of the present invention is to provide a headset having ferrite beads that may shield electromagnetic waves emitted from a mobile terminal.

In accordance with an aspect of the present invention, a headset is provided. The headset includes an ear jack, an ear jack Printed Circuit Board (PCB) connected to the ear jack, a speaker, and a cable having an antenna in which one end of the antenna is connected to the ear jack PCB, and having an audio line in which one end of the audio line is connected to the ear jack PCB through ferrite beads and the other end of the audio line is connected to the speaker.

The speaker may include a left speaker and a right speaker, and the audio line may include a left line connected to the left speaker, a right line connected to the right speaker and a ground line.

In accordance with another aspect of the present invention, a headset is provided. The headset includes an ear jack, an ear jack PCB connected to the ear jack, a microphone, a microphone PCB connected to the microphone, a cable having an antenna connected to one end of the ear jack PCB, and a first audio line connected to one end of the ear jack PCB through ferrite beads and connected to the other end of the microphone PCB, a speaker, and a second audio line connected to one end of the microphone PCB and connected to the other end of the speaker.

The second audio line may be connected to the microphone PCB through ferrite beads.

The speaker may include a left speaker and a right speaker, and the first audio line and the second audio line each may include a left line, a right line and a ground line.

The cable may further include a microphone line and a switch line, each connected to the ear jack PCB through ferrite beads.

In accordance with still another aspect of the present invention, a headset is provided. The headset includes an ear jack, an ear jack PCB connected to the ear jack, a microphone, a microphone PCB connected to the microphone, a cable having a first audio line in which one end of the first audio line is connected to the ear jack PCB through ferrite beads and the other end the first audio line is connected to the microphone PCB, and having an antenna in which one end of the antenna is connected to the ear jack PCB and the other end of the antenna is connected to the ground line, a speaker, and a second audio line in which one end of the second audio line is connected to the microphone PCB through ferrite beads and the other end of the second audio line is connected to the speaker.

The first audio line may include a left line, a right line and a ground line.

The cable may further include a microphone line and a switch line, and the microphone line and the switch line may be connected to the ear jack PCB through ferrite beads.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1A is a perspective view illustrating a conventional headset;

FIG. 1B is a diagram illustrating connection of an ear jack PCB and a microphone PCB of the conventional headset;

FIG. 2 is a diagram illustrating connection of an ear jack PCB and a speaker of a headset according to an exemplary embodiment of the present invention;

FIG. 3 is a diagram illustrating connection of an ear jack PCB and a microphone PCB of a headset according to an exemplary embodiment of the present invention;

FIG. 4 is a diagram illustrating a connection of an ear jack PCB and a microphone PCB of a headset according to an exemplary embodiment of the present invention; and

FIG. 5 is a diagram illustrating connection of an ear jack PCB and a microphone PCB of a headset according to an exemplary embodiment of the present invention.

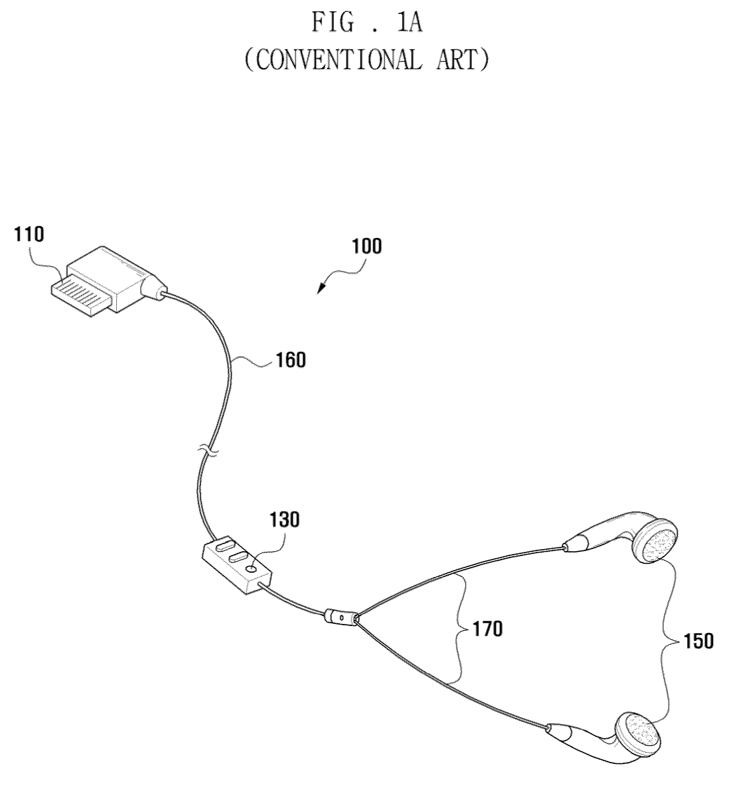

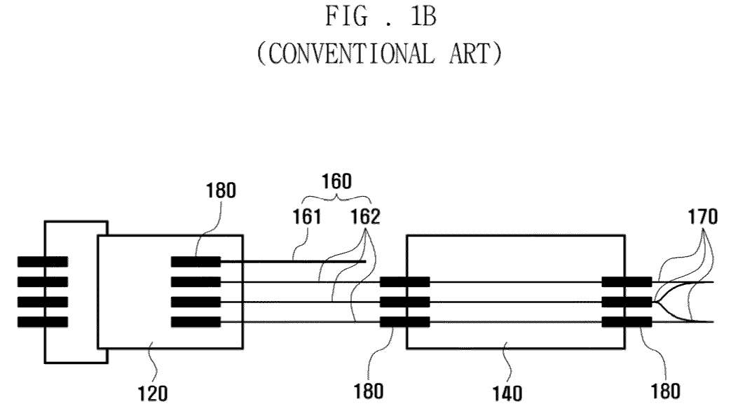

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In exemplary embodiments of the present invention, a headset is a device, such as an earphone or a headphone, for enabling a user to listen to sound output from a mobile terminal.

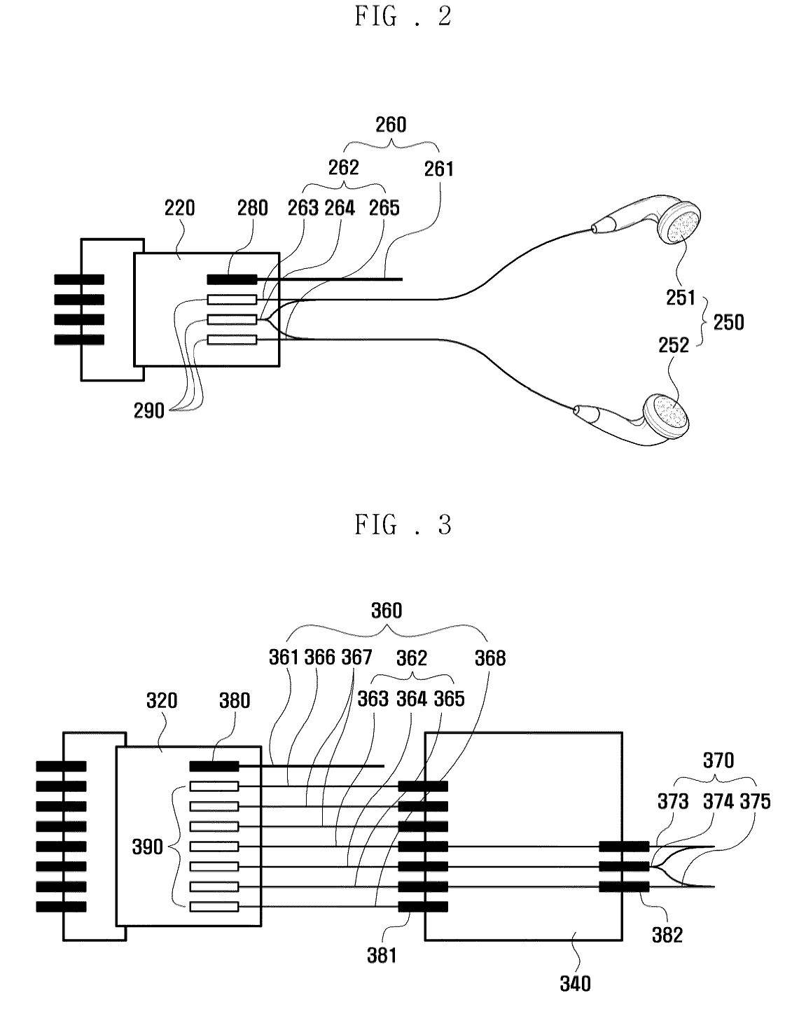

FIG. 2 is a diagram illustrating connection of an ear jack Printed Circuit Board (PCB) and a speaker of a headset according to an exemplary embodiment of the present invention.

Referring to FIG. 2, an ear jack PCB 220 and a speaker 250 are connected through a cable 260. The cable 260 includes an antenna 261 and an audio line 262. In an exemplary implementation, the antenna 261 is used for receiving an FM radio broadcasting frequency. However, the antenna 261 is not limited thereto and may be used for receiving other frequencies. One end of the antenna 261 is connected to the ear jack PCB 220 through a PCB pad 280.

The speaker 250 includes a left speaker 251 and a right speaker 252. The left speaker 251 and the right speaker 252 are for inserting into a user's left ear and right ear, respectively.

The audio line 262 includes a left line 263, a right line 265 and a ground line 264. The left line 263 is connected to the left speaker 251 and the right line 265 is connected to the right speaker 252. The ground line 264 is divided into two lines, one line of which is connected to the left speaker 251 and the other line is connected to the right speaker 252. In an exemplary implementation, one end of the audio line 262 is connected to the ear jack PCB 220 through ferrite beads 290. However in another exemplary implementation, the audio line 262 may be connected to the ear jack PCB 220 through PCB pads (not illustrated) and through the ferrite beads 290.

The ferrite beads 290 are made of a ferrite material and generally have a small cylindrical shape. The ferrite beads 290 include both a resistance characteristic (R) and an inductance characteristic (L). The ferrite beads 290 operate like a general conductive wire in a low frequency band and operate like an inductor having high impedance in a high frequency band. As a result, the ferrite beads 290 perform a function as a filter for removing noise in a high frequency band. Further, when the headset is used for a mobile terminal such as a mobile phone, the ferrite beads 290 may perform a function of absorbing unintentional emission of electromagnetic waves that would otherwise flow through the cable of the headset and may affect the health of a user. When the ferrite beads 290 are used in an electric circuit, the ferrite beads 290 are embodied in a mountable chip form. In an exemplary implementation, the ferrite beads 290 are embodied in a chip form.

In an exemplary embodiment of the present invention, when the audio line 262 is connected to the ear jack PCB 220 through the ferrite beads 290, the ferrite beads 290 remove noise occurring in the audio line 262. Therefore, reception performance of the antenna 261 may be improved. Further, the ferrite beads 290 may shield electromagnetic waves occurring in the mobile terminal.

FIG. 3 is a diagram illustrating connection of an ear jack PCB and a microphone PCB of a headset according to an exemplary embodiment of the present invention.

Referring to FIG. 3, an ear jack PCB 320 and a microphone PCB 340 are connected through a cable 360. The cable 360 includes an antenna 361, a first audio line 362, a system ground line 366, microphone lines 367 and a switch line 368. One end of the antenna 361 is connected to the ear jack PCB 320 through a first PCB pad 380.

The first audio line 362 includes a left line 363, a right line 365 and a ground line 364. The system ground line 366 is used for grounding the headset. The microphone lines 367 are lines for operating a microphone and include a positive (+) terminal line and a negative (−) terminal line. The switch line 368 connects to a switch for turning the headset on/off. The first audio line 362, system ground line 366, microphone lines 367 and the switch line 368 each have one end connected to the ear jack PCB 320 through the ferrite beads 390 and the other end connected to the microphone PCB 340 through second PCB pads 381. Accordingly, when all lines of the cable 360, except for the antenna 361, are connected to the ear jack PCB 320 through the ferrite beads 390 in the cable 360, noise occurring in the lines may be removed.

A second audio line 370 has one end connected to the microphone PCB 340 through third PCB pads 382 and the other end connected to a speaker (not illustrated). The second audio line 370 includes a left line 373, a right line 375 and a ground line 374. The speaker includes a left speaker and a right speaker. The left line 373 is connected to the left speaker and the right line 375 is connected to the right speaker. The ground line 374 is divided into two lines, one line of which is connected to the left speaker and the other line is connected to the right speaker.

The first audio line 362 and the second audio line 370 are connected to each other in the microphone PCB 340. In more detail, the left line 363 of the first audio line 362 is connected to the left line 373 of the second audio line 370, the right line 365 of the first audio line 362 is connected to the right line 375 of the second audio line 370 and the ground line 364 of the first audio line 362 is connected to the ground line 374 of the second audio line 370.

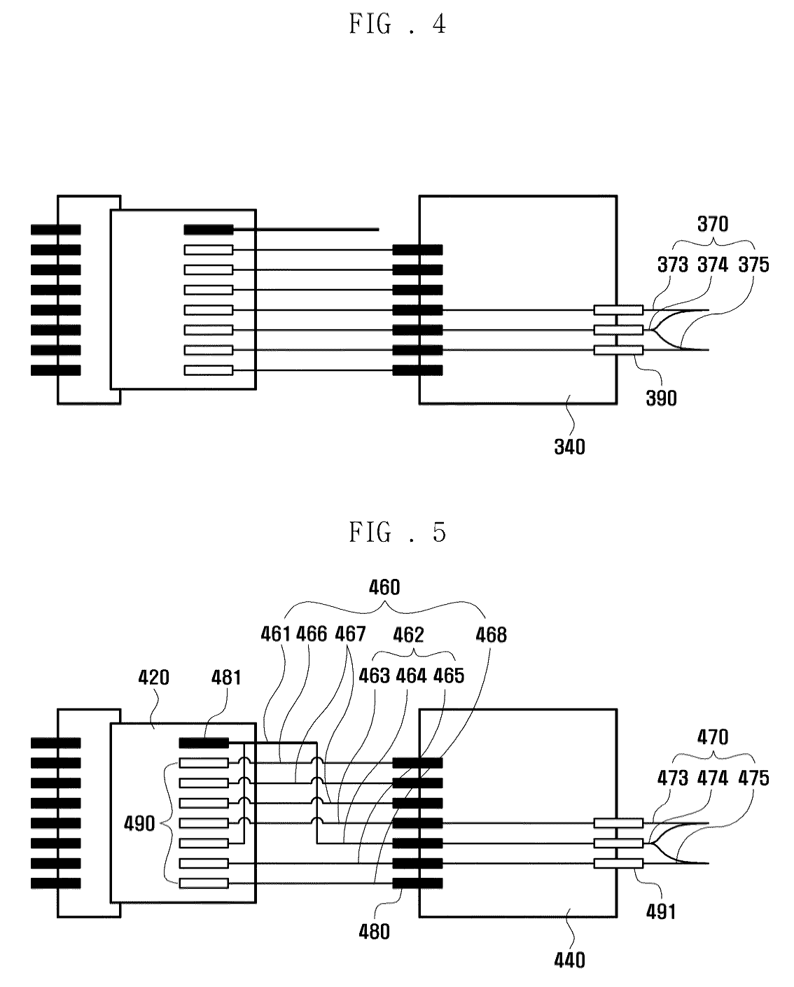

FIG. 4 is a diagram illustrating a connection of an ear jack PCB and a microphone PCB of a headset according to an exemplary embodiment of the present invention.

Referring to FIG. 4, the second audio line 370 may be connected to the microphone PCB 340 through the ferrite beads 390. In such a structure, noise occurring in lines may be more effectively removed. Thereby, performance of the antenna may be improved.

FIG. 5 is a diagram illustrating connection of an ear jack PCB and a microphone PCB of a headset according to an exemplary embodiment of the present invention.

Referring to FIG. 5, an ear jack PCB 420 and a microphone PCB 440 are connected through a cable 460. The cable 460 includes an antenna 461, a first audio line 462, a system ground line 466, microphone lines 467 and a switch line 468. The first audio line 462 includes a left line 463, a right line 465 and a ground line 464. One end of the first audio line 462 is connected to the ear jack PCB 420 through first ferrite beads 490 and the other end of the first audio line 462 is connected to the microphone PCB 440 through PCB pads 480.

One end of the antenna 461 is connected to the ear jack PCB 420 through a PCB pad 481 and the other end of the antenna 461 is connected to the ground line 464.

A second audio line 470 has one end connected to the microphone PCB 440 through second ferrite beads 491 and the other end connected to a speaker (not illustrated). The second audio line 470 includes a left line 473, a right line 475 and a ground line 474. The speaker includes a left speaker and a right speaker. The left line 473 is connected to the left speaker and the right line 475 is connected to the right speaker. The ground line 474 is divided into two lines, one line of which is connected to the left speaker and the other line is connected to the right speaker.

The first audio line 462 and the second audio line 470 are connected to each other in the microphone PCB 440. In more detail, the left line 463 of the first audio line 462 is connected to the left line 473 of the second audio line 470, the right line 465 of the first audio line 462 is connected to the right line 475 of the second audio line 470 and the ground line 464 of the first audio line 462 is connected to the ground line 474 of the second audio line 470.

In an exemplary implementation, the ground line 464 of the first audio line 462 is connected to the ear jack PCB 420 via the antenna 461 through one of the first ferrite beads 490 and the ground line 474 of the second audio line 470 may be connected to the microphone PCB 440 through one of the second ferrite beads 491. Because the first ferrite beads 490 have high impedance in a high frequency band, the antenna 461 has the same effect as an antenna in which the end of the antenna opposite to the end connected to the ear jack PCB 420 is unconnected. Therefore, a signal may be transmitted and received through the antenna 461. In this case, the ground line 474 in the microphone PCB 440 may be used as the antenna 461. Thereby, the length of the cable 460 may be reduced.

As described above, according to exemplary embodiments of the present invention, by connecting an audio line within a cable of a headset to a PCB through ferrite beads, performance of an antenna within the cable may be improved.

Further, when using a headset in a mobile terminal, ferrite beads may shield electromagnetic waves emitted from the mobile terminal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A headset comprising:
an ear jack;
an ear jack Printed Circuit Board (PCB) connected to the ear jack;
a speaker; and
a cable comprising an antenna in which one end of the antenna is connected to the ear jack PCB, and an audio line in which one end of the audio line is connected to the ear jack PCB through ferrite beads and the other end of the audio line is connected to the speaker.

2. The headset of claim 1, wherein the speaker comprises a left speaker and a right speaker.

3. The headset of claim 1, wherein the audio line comprises a left line connected to the left speaker, a right line connected to the right speaker, and a ground line.

4. The headset of claim 1, wherein the antenna is connected to the ear jack PCB through a PCB pad.

5. The headset of claim 1, wherein the ferrite beads have a cylindrical shape and comprise ferrite material.

6. A headset comprising:
an ear jack;
an ear jack Printed Circuit Board (PCB) connected to the ear jack;
a microphone;
a microphone PCB connected to the microphone;
a cable comprising an antenna in which one end of the antenna is connected to the ear jack PCB, and a first audio line in which one end of the first audio line is connected to the ear jack PCB through first ferrite beads and the other end of the first audio line is connected to the microphone PCB;
a speaker; and
a second audio line in which one end of the second audio line is connected to the microphone PCB and the other end of the second audio line is connected to the speaker.

7. The headset of claim 6, wherein one end of the second audio line is connected to the microphone PCB through second ferrite beads.

8. The headset of claim 6, wherein the antenna is connected to the ear jack PCB through a first PCB pad.

9. The headset of claim 6, wherein the speaker comprises a left speaker and a right speaker.

10. The headset of claim 6, wherein the first audio line comprises a left line, a right line and a ground line, each connected to a left line, a right line and a ground line of the second audio line, respectively.

11. The headset of claim 10, wherein the cable further comprises a microphone line and a switch line, each connected to the ear jack PCB through the first ferrite beads.

12. The headset of claim 11, wherein the first audio line, the microphone line and the switch line are connected to the microphone PCB through second PCB pads.

13. The headset of claim 10, wherein the other end of the antenna is connected to the ground line of the second audio line.

14. The headset of claim 10, wherein the ground line of the first audio line is connected to the ear jack PCB via the antenna through one of the first ferrite beads.

15. The headset of claim 10, wherein the ground line of the second audio line is connected to the microphone PCB through one of first ferrite beads.
